(19) United States
(12) Patent Application Publication
(10) Pub. No.: US 2026/0027653 A1
(43) Pub. Date: Jan. 29, 2026

(54) VEHICLE WITH WELDED BUS BAR CONNECTIONS

(71) Applicant: FORD GLOBAL TECHNOLOGIES, LLC, Dearborn, MI (US)

(72) Inventors: Paul John Bojanowski, Macomb Township, MI (US); Michael Orr, Ferndale, MI (US); Jo Ann Marie Clarke, Plymouth, MI (US)

(21) Appl. No.: 18/781,602

(22) Filed: Jul. 23, 2024

(51) Int. Cl. B23K 26/22; B23K 26/046; B23K 103/10; B23K 103/12; H01M 50/505; H01M 50/516

(52) U.S. Cl. CPC B23K 26/22; B23K 26/046; H01M 50/505; H01M 50/516; B23K 2103/10; B23K 2103/12

(57) ABSTRACT

In a high voltage vehicle electronics system, electronic components having tabs are welded to a bus bar using pulsed laser welding. Each tab is welded to the bus bar with an array of spot welds. Each spot weld includes an inner region formed by laser welding in a keyhole mode and an outer region formed by laser welding in a conduction mode. The energy density applied to the inner region is between ten and twenty times the energy density applied to the outer region.

### TECHNICAL FIELD

This disclosure pertains to laser welding. More particularly, this disclosure pertains to pulsed laser welding of a high voltage electrical system for an electric vehicle.

### BACKGROUND

Laser welding works on the principle of using a focused beam of light, typically generated by a laser source, to heat and melt the materials being joined. The laser beam is directed precisely onto the joint area, where it rapidly heats the material to its melting point, creating a weld pool. Once the laser energy is removed from a given region, the melted material solidifies, forming a strong bond between the parts.

Continuous wave laser welding involves the continuous emission of laser energy onto the workpiece without interruption. The focus region is continuously moved along the material. Pulsed laser welding involves emitting laser energy in short pulses, with each pulse lasting for a fraction of a second. The focus region is typically constant during a pulse and is moved to a different location between pulses.

Laser welding is a highly versatile joining process, but it presents unique challenges when working with materials like copper and aluminum due to their distinct properties. Copper and aluminum have relatively high thermal conductivities. This high thermal conductivity makes it challenging to achieve sufficient heating at the weld joint. Copper and aluminum are also highly reflective to infrared radiation, including the wavelength commonly used in many laser welding processes. This reflectivity can result in poor absorption of laser energy, leading to insufficient heating.

### SUMMARY

A method of welding flat metal parts includes placing a first surface of a first part against a first surface of a second part and focusing energy from one or more lasers on a second surface of the first part to create an array of spot welds. Each spot weld has an inner region surrounded by an outer region. An energy density applied to the inner region exceeds the energy density applied to the outer region by a factor of between ten and twenty. Inner regions of adjacent spot welds may not intersect. Each spot weld may be formed by focusing the energy of a first laser on the inner region and simultaneously focusing the energy of a second laser on the outer region. The first and second lasers may apply energy to the second surface in pulses while the focus regions of the lasers are moved between spots welds between pulses. The first and second part may both be made of copper. The first and second part may both be made of aluminum. One of the parts may be made of copper while the other is made of aluminum. One of the parts may be a terminal tab of a battery cell while the other may be a bus bar. One of the parts may be a terminal tab of a power electronics module while the other may be a bus bar.

A power electronics system includes a bus bar and a plurality of electronic components. The bus bar has a first surface and a second surface. Each of the electronic components has a tab with a third surface adjacent to the second surface. Each of the electronic components may be a battery cell. The electronic components may include a power electronics module configured to convert Direct Current (DC) power to Alternating Current (AC) power. The tabs are welded to the bus bar with an array of welds. Each weld includes first and second regions of altered grain structure. The first region of altered grain structure penetrates through the bus bar into the tab and has a first cross sectional area at the first surface. The second region of altered grain structure penetrating into the bus bar and has a second cross sectional area at the first surface. The second cross sectional area is between five and twenty times the first cross sectional area. The bus bar may be made of aluminum. The tab may be made of copper.

A power electronics system includes a plurality of electronic components and a bus bar. Each of the electronic components has a tab with a first surface and a second surface. Each of the electronic components may be a battery cell. The electronic components may include a power electronics module configured to convert Direct Current (DC) power to Alternating Current (AC) power. The bus bar has a third surface adjacent to the second surfaces of the tabs. The tabs are welded to the bus bar with an array of welds. Each weld includes first and second regions of altered grain structure. The first region penetrates through the tab into the bus bar and has a first cross sectional area at the first surface. The second region penetrating into the tab and has a second cross sectional area at the first surface. The second cross sectional area is between five and twenty times the first cross sectional area. The bus bar may be made of aluminum. The tabs may be made of copper.

### BRIEF DESCRIPTION OF THE DRAWINGS

FIG. 1 illustrates a block diagram of an electric vehicle.

FIG. 2 illustrates a structure of a high voltage electrical system suitable for use in an electric vehicle such as the vehicle of FIG. 1.

FIG. 3 illustrates a structure of a battery suitable for use in the high voltage electrical system of FIG. 2.

FIG. 4 is a cross-sectional view of two pieces of metal being laser welded in conductive mode.

FIG. 5 is a cross-sectional view of two pieces of metal being laser welded in keyhole mode.

FIG. 6 is a cross-sectional view of two pieces of metal, such as tabs and bus bars of the electrical system of FIG. 2, being welded in a pulsed hybrid keyhole-conductive mode.

FIG. 7 is a top view of the two pieces of metal after welding with the pulsed hybrid keyhole-conductive method.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

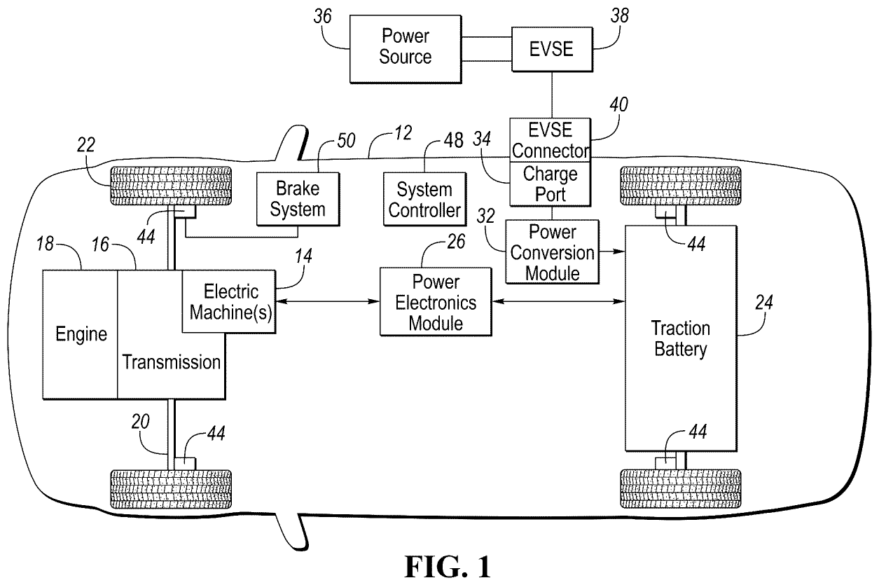

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine. For example, battery 24 may provide a DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24. In other embodiments, EV 12 is a battery electric vehicle (BEV). In a BEV configuration, EV 12 does not include an engine.

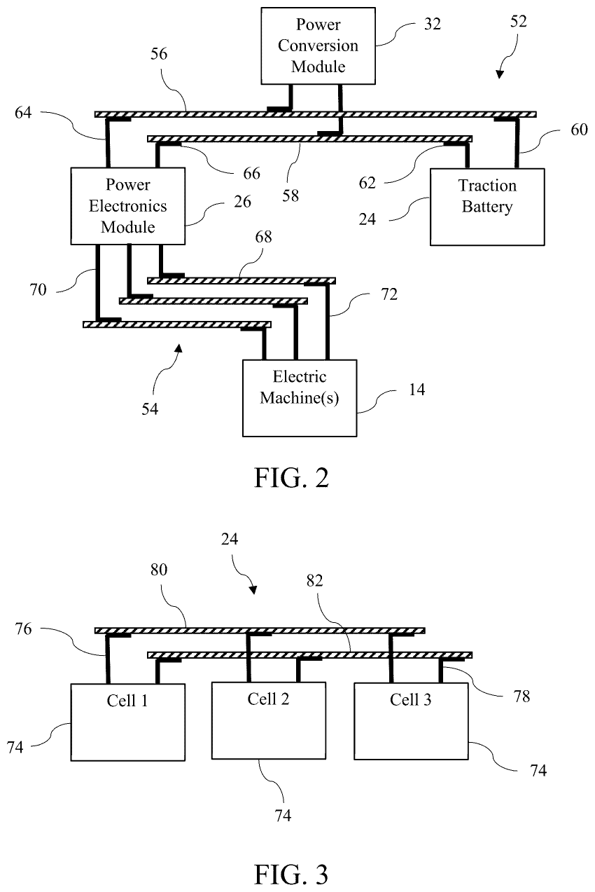

FIG. 2 illustrates the high voltage electrical system of EV 12, which connects the electric motor 14, the power electronics module 26, the battery 24, and the power conversion module 32 (if present). The high voltage electrical system includes a high voltage DC bus 52 and a high voltage AC bus 54.

The high voltage DC bus 52 may include a positive bus bar 56 and a negative bus bar 58. The bus bars may be copper, aluminum, or other electrically conductive material. The traction battery 24 includes a positive terminal 60 electrically connected to the positive bus bar 56 and a negative terminal 62 electrically connected to the negative bus bar 58. Similarly, the power electronics module includes a positive DC terminal 64 electrically connected to the positive bus bar 56 and a negative DC terminal 66 electrically connected to the negative bus bar 58. If present, the power conversion module 32 includes a positive terminal electrically connected to the positive bus bar 56 and a negative terminal electrically connected to the negative bus bar 58. The terminals may be copper, aluminum, or other electrically conductive material which may be the same material as the corresponding bus bar or may be a different material. The electrical connections may be formed by welding, such as laser welding.

The high voltage AC bus 54 may include three bus bars 68 each corresponding to one phase of a three-phase AC electrical signal. The power electronics module 26 and the electric motor 14 each include three AC terminals 70 and 72, each electrically connected to a corresponding one of the bus bars 68. The material options for the bus bars 68 and for the terminals 70 and 72 are the same as with the high voltage DC bus 52. The electrical connections may be formed by welding, such as laser welding.

FIG. 3 illustrates a structure suitable for the traction battery 24. The battery may include a set of battery cells 74. Each battery cell 74 may include a positive terminal 76 and a negative terminal 78. The terminals may be copper, aluminum, or other electrically conductive material. Each positive terminal may be electrically connected to positive bus bar 80 while each negative terminal may be electrically connected to negative bus bar 82. The bus bars may be copper, aluminum, or other electrically conductive material which may be the same material as the corresponding terminals or may be a different material. The electrical connections may be formed by welding, such as laser welding.

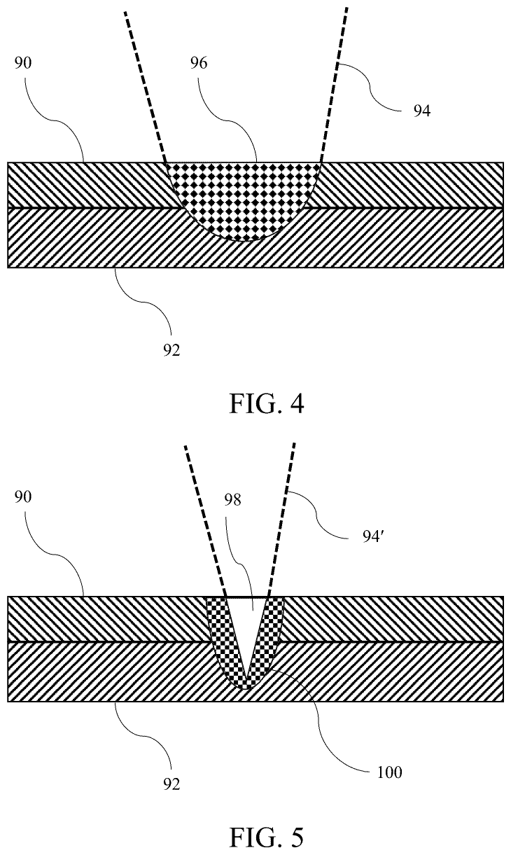

In laser welding, two primary modes of operation are conductive mode and keyhole mode. These modes differ in their approach to material interaction and heat transfer, leading to distinct welding characteristics and applications. FIGS. 4 and 5 illustrate the differences in these modes when used to create a lap weld between an upper piece 90 and a lower piece 92.

In conductive mode laser welding, as illustrated in FIG. 4, the laser beam's energy is primarily absorbed at the material's surface, causing localized heating. The beam 94 is focused on a comparatively large area leading to a comparatively low energy density. The heat conducted through the material creates a shallow molten pool 92 at the surface, where the fusion occurs. When the molten pool cools, it re-solidifies with a distinctly different grain pattern than the regions that were never melted. The re-solidified region bonds to both the upper piece 90 and the lower piece 92, thereby joining the two pieces to one another both mechanically and electrically.

Keyhole mode laser welding, as illustrated in FIG. 5, involves the formation of a vapor-filled void or “keyhole” within the material's thickness. The beam 94′ is focused on a comparatively small area leading to a comparatively high energy density relative to conductive mode. The intense laser energy creates a localized vaporization of the material, forming a cavity 98 that extends into the depth of the material. The keyhole acts as a channel for the laser beam to penetrate deeply into the material, allowing for significant deeper weld penetration than conductive mode. A molten pool of material 100 surrounds the void 98. As with conductive mode, when the molten pool cools, it re-solidifies with a distinctly different grain pattern, bonding mechanically and electrically to both the upper piece 90 and the lower piece 92. When continuous wave laser welding is performed in keyhole mode, spattering may occur as the molten metal flows into the void behind the advancing laser. The spattering issue does not occur in pulsed laser welding. However, other issues, such as crack development, may occur due to the rapid heating and cooling around the keyhole.

There are a limited number of parameters which can be adjusted to optimize the weld strength and mitigate adverse effects such as crack formation. These include the beam intensity, wavelength, pulse duration, ramp rates at the beginning and end of the pulse, and the area of the focus region. These parameters are tuned based on the thicknesses of the top and bottom pieces and on the materials of the top and bottom pieces. However, sometimes it is not possible to find parameters combinations which provide adequate welding strength without adverse effects. The inventors have discovered a technique which provides good weld quality and minimal adverse effects in such circumstances.

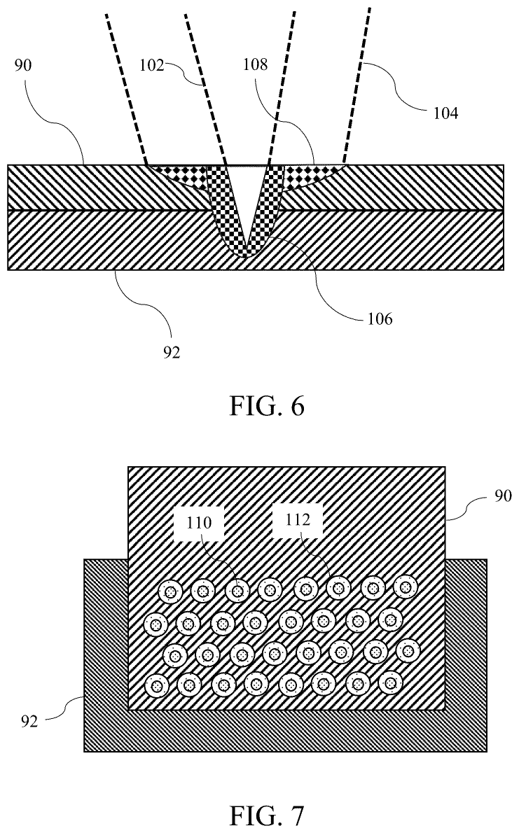

As illustrated in FIG. 6, two lasers focused on the top surface. An inner beam 102 is focused on a narrow inner region. An outer beam 104 is focused on a wider outer region surrounding and encompassing the inner region. The energy density in the inner region is between ten and twenty times as high as the energy density in the outer region. As such, the inner beam operates in keyhole mode to create a deep penetrating molten pool of material. When this molten pool solidifies after the beam is terminated, a first region of altered grain structure 106 is formed. The first region extends through the upper piece into the lower piece and bonds to both pieces, thereby bonding them to one another. The outer beam operates in conductive mode and produces a much wider, shallower molten pool. When this molten pool solidifies after the beam is terminated, a second region of altered grain structure 108 is formed. This second region extends into the top piece but does not necessarily extend through the top piece into the bottom piece.

FIG. 7 is a top view showing the array of welds after the molten pools have hardened. Each weld includes an inner region of altered grain structure 110 and an outer region of altered grain structure 112. The area of the outer region 112 at the top surface is between five and twenty times the area of the inner region at the top surface. These regions may have different colors or other visibly distinguishable attributes. The welds of the array are separated enough that the outer regions do not intersect one another.

When welding dissimilar metals like copper and aluminum, the formation of intermetallic compounds at the weld interface must be considered. Intermetallics can influence the mechanical properties and reliability of the joint, potentially affecting its performance under various conditions. Proper process control and selection of welding parameters help minimize the formation of detrimental intermetallic phases, ensuring the integrity of the weld joint. With the hybrid keyhole-conductive process described above, twice as many parameters are available for tuning.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method of welding flat metal parts, the method comprising:
placing a first surface of a first part against a first surface of a second part;
focusing energy from one or more lasers on a second surface of the first part opposite the first surface of the first part, to create an array of spot welds, each spot weld having an inner region surrounded by an outer region, wherein an energy density applied to the inner region exceeds the energy density applied to the outer region by a factor of between ten and twenty.

2. The method of claim 1 wherein the inner regions of adjacent spot welds do not intersect.

3. The method of claim 1, wherein each spot weld is formed by focusing the energy of a first of the one or more lasers on the inner region and simultaneously focusing the energy of a second of the one or more lasers on the outer region.

4. The method of claim 3, wherein the first and second lasers apply energy to the second surface in pulses and focus regions of the lasers are moved between spots welds between pulses.

5. The method of claim 1, wherein the first part and the second part are made of copper.

6. The method of claim 1, wherein the first part and the second part are made of aluminum.

7. The method of claim 1, wherein one of the first and second parts is made of copper and another of the first and second parts is made of aluminum.

8. The method of claim 1, wherein one of the first and second parts is a terminal tab of a battery cell, and another of the first and second parts is a bus bar.

9. The method of claim 1, wherein one of the first and second parts is a terminal tab of a power electronics module, and another of the first and second parts is a bus bar.

10. A power electronics system comprising:
a bus bar having a first surface and a second surface; and
a plurality of electronic components each having a tab with a third surface adjacent to the second surface, the tabs welded to the bus bar with an array of welds, wherein each weld comprises:
a first region of altered grain structure penetrating through the bus bar into the tab, the first region having a first cross sectional area at the first surface; and
a second region of altered grain structure penetrating into the bus bar, the second region having a second cross sectional area at the first surface, the second cross sectional area being between five and twenty times the first cross sectional area.

11. The power electronics system of claim 10 wherein the bus bar is made of aluminum.

12. The power electronics system of claim 10 wherein the tab is made of copper.

13. The power electronics system of claim 10 wherein each electronic component of the plurality of electronic components is a battery cell.

14. The power electronics system of claim 10 wherein the plurality of electronic components comprises a power electronics module configured to convert Direct Current (DC) power to Alternating Current (AC) power.

15. A power electronics system comprising:
a plurality of electronic components each having a tab with a first surface and a second surface; and
a bus bar having a third surface adjacent to the second surfaces of the tabs, the tabs welded to the bus bar with an array of welds; wherein each weld comprises:
a first region of altered grain structure penetrating through the tab into the bus bar, the first region having a first cross sectional area at the first surface; and
a second region of altered grain structure penetrating into the tab, the second region having a second cross sectional area at the first surface, the second cross sectional area being between five and twenty times the first cross sectional area.

16. The power electronics system of claim 15 wherein the bus bar is made of aluminum.

17. The power electronics system of claim 15 wherein the tab is made of copper.

18. The power electronics system of claim 15 wherein each electronic component of the plurality of electronic components is a battery cell.

19. The power electronics system of claim 15 wherein the plurality of electronic components comprises a power electronics module configured to convert Direct Current (DC) power to Alternating Current (AC) power.
